(19) United States
(12) Patent Application Publication
(10) Pub. No.: US 2007/0143736 A1
(43) Pub. Date: Jun. 21, 2007

(54) Workflow Development Platform

(75) Inventors: Robert Moriarty, Tampa, FL (US); Steven Mandel, Tampa, FL (US)

Correspondence Address: SMITH HOPEN, PA, 180 PINE AVENUE NORTH, OLDSMAR, FL, 34677, US

(73) Assignee: MICROSYSTEMS TECHNOLOGY, INC., Tampa, FL (US)

(21) Appl. No.: 11/609,001

(22) Filed: Dec. 11, 2006

Related U.S. Application Data
(60) Provisional application No. 60/597,561, filed on Dec. 9, 2005.

(51) Int. Cl. G06F 9/44; G06F 17/00; G06F 15/00; G06F 3/00; G06F 9/00

(52) U.S. Cl. 717/100; 715/530; 715/700

(57) ABSTRACT

The present invention is a workflow processing system that encapsulates common workflow tasks into independent components which are visually represented in a workflow diagram at design-time. The platform accepts third-party and/or customer provided components easily without disrupting the common code base. This allows a customer to have one platform to capture/accept the different types of information their operations require, define their business processes, and deliver the information to their receiving destination of choice.

### CROSS REFERENCE TO RELATED APPLICATIONS

This application claims priority to currently pending U.S. Provisional Patent Application 60/597,561, entitled, “Workflow Development Platform”, filed Dec. 9, 2005.

### FIELD OF INVENTION

This invention relates to document and workflow automation, and more specifically to a visual, object-oriented architecture for configuring said automation.

### BACKGROUND OF THE INVENTION

Customers frequently have specific functional requirements which end up in a common build for a software product although many will not need the new functionality. New features may disrupt existing logic in compiled code and make the code/product more complex. Accordingly, there have been attempts to permit end-users to configure the workflow process according to their specific needs. Workflow is a term used to describe the tasks, procedural steps, organizations or people involved, required input and output information, and tools needed for each step in a business process. Most workflow systems are primarily designed for user interaction with exception transactions routed to humans via computer controlled operator queues. This invention can operate along those same lines, operator-less, or a combination of both, depending on the goal(s) of the workflow designer. There are several products that permit customization of document and workflow automation to some degree.

Technology from Kofax (Irvine, Calif.) sold under the MOHOMINE brand name automates data entry, document routing and categorization for unstructured documents, whether paper-based or electronic.

Visiflow Workflow Builder, available from Exigen, Inc. (San Francisco, Calif.) is based on re-usable objects (such as scan, fax, optical character recognition (“OCR”), index, etc), which provide functionality for processes and tasks within the flow. To create workflows, administrators drag-and-drop graphical representations from a palette of pre-built automation objects representing document capture, information transformation, and automation of workflow.

FormWare's WorkFlow Designer by Captiva Software (San Diego, Calif.) provides a graphical diagram workspace for modeling document workflow processes.

BizTalk, available from Microsoft Corporation (Redmond, Washington) provides a graphical user interface of its workflow process through the Visual Studio IDE.

While the aforementioned technologies advanced the art by providing some visual representation of document workflow there exists a long-felt but unfulfilled need in the art for a system that expands the visualization concept to real time processing of the actual workflow process.

Another long-felt but unfulfilled need in the art exists for a component-based architecture to workflow design that permits third parties to develop their own custom components without disrupting the stability of the base platform.

Yet another long-felt but unfulfilled need in the art exists for a component-based architecture wherein the third party developed tools do not differ visually between each other or the standard tools included in with the platform.

### SUMMARY OF INVENTION

The present invention is a graphical workflow editing system that encapsulates common workflow tasks into independent components which are visually represented in a workflow diagram at design-time. Via a system-provided API that allows each tool to be totally independent of all other tools, the platform accepts third-party and/or customer provided components easily without disrupting the common code base. This allows a customer to have one platform to capture/accept the different types of information their operations require, define their business processes, and deliver the information to their receiving destination of choice.

An embodiment of the invention includes a desktop workspace and a plurality of object-oriented tools that are selectively dragged and dropped onto the workspace. The workspace is a panel in the editor's graphic user interface (herein “GUI”) that accepts icons representing tools a user drops on it. The workspace is auto-sized to grow and shrink as the application form dimensions change. A Cartesian grid may also overlay the workspace to help align and organize tools dropped on it. The workspace starts out empty until a tool is dragged from a toolbox collection onto the workspace. The location on the workspace where the tool is placed is arbitrary. The end user may reposition the tool at any time to accommodate personal preferences, visual organization or the like. The logical flow of the system, i.e. left to right, right to left, top to bottom, or bottom to top, is arbitrary and determined by the editor when subsequent tools are placed on the workspace and connected.

The toolbox collection contains a plurality of tools, typically viewable as icons with a short alphanumeric description underneath. Each tool performs at least one predefined role in a workflow process. The toolbox collection may group the tools according to the type of predefined role that they perform. For example, the exemplary embodiment described in this specification involves document workflows that include capturing document images, reading the text and performing tasks according to the information found on the document. Groupings of tools pertinent to this embodiment include import tools, image tools, recognition tools, decision tools, data collection tools, user interface tools, export tools, miscellaneous tools, and special tools.

As an end user initially drags a tool from the toolbox collection, the visual state of the tool is modified during the drag operation. This may include, but is not limited to, altering the opacity of the tool icon. When the end user positions the tool over the workspace and drops the tool the visual state of the tool is again modified, in this case, to full opacity. User feedback may be further enhanced by modifying the visual state of the tool icon responsive to predetermined events including mouse-over, click, double-click, mouse-down, enter, and the like.

When a plurality of tools are dropped onto a workspace each tool may have functionality but the order and interoperation of the tools must also be defined. Accordingly, a graphical connector is provided by visually linking one tool to another according to the tool's role in the workflow process. Each tool is object-oriented and contains its own parameters for internal processing. For example, at the end of each workflow, an “end” tool terminates the process. This “end” tool naturally has no outgoing connectors. Other tools such as an import tool will typically have a single outgoing connector. Still other tools, such as those that classify images by matching them to known templates may have multiple outgoing connectors to accommodate matches and non-matches. Thus, when a classify image tool is dropped onto the workspace it will automatically display at least two outgoing graphical connectors. In the embodiment of the invention described herein, the graphical connectors are lines with arrows. The end user drags the arrowhead portion of the graphic connector over the next tool in the workflow process and drops the arrowhead over that tool. The two tools are then linked. If the end user repositions either tool on the workspace the graphical connectors are automatically redrawn to maintain a visual connection for the end user observing the GUI.

When a tool is dropped onto the workspace and the tool is clicked or otherwise selected by the end user, a property editor is displayed to the end user to review or modify properties exposed by the tool. Not all tools necessarily have editable properties such as the “end” tool for terminating the workflow process. If the tool does have editable properties, it depends on the type of tool and its predefined role. For example, an import tool may have a path to a source of files to be imported into the workflow process. A database lookup tool will typically need at least a connection string to locate the database to be queried. An email notification tool will typically need a property value for an SMTP server. An export tool will typically require a file path wherein the exported files will be saved.

The graphical workflow editor has a viewer mode for monitoring the workflow process whereby each tool provides visual indicia responsive to its activity state in the workflow process. The activity states include, but are not limited to, inactive and processing. In addition, the graphical connector may provide visual indicia responsive to the transition from one tool to another during the workflow process in the viewer mode. Visual indicia may include, but is not limited to, color change, size modification, opacity change, and associated animation. Thus, each tool and connector provides visual indicia responsive to its activity state in the workflow process, the viewer mode executing the workflow process responsive to end user initiation. The viewer mode may incrementally step through the workflow process one tool at a time, stopping after each tool functions and requiring the end user to manually step through each subsequent tool. An output window in the GUI permits the end user to monitor the output of each tool via the creation of icons representing output and a textual description of what the tool has completed as the workflow process incrementally steps through one tool at a time.

While in viewer mode, each tool may display an integer associated with the number of functions executed by the tool. In the case of a document-related workflow, each function executed may represent a document that is processed by the tool. For example, if the workflow process includes the job of classifying 50 faxes according to their document type (i.e., invoice, credit application, mortgage note, or payment stub) then the workflow process will handle a batch of 50 jobs. Each time a tool processes an individual fax it performs one job from the batch of jobs and increments the integer value by one. In certain workflows, data does not always follow the same path. For example, if the workflow process identifies certain faxes as invoices then certain tools in the workflow process handling invoices will display an integer value equal to the invoices processed through those tools.

The workflow editor also includes the ability to import third party tools that follow predefined specifications. These tools integrate seamlessly into the workflow editor and permit end users and third party vendors supporting those users to have almost limitless functionality in the workflow editor. By encapsulating data processing and business logic into object-oriented tools, an end user having limited experience using the workflow editor can add highly sophisticated and complex processes to their workflow by simply dragging and dropping their newly developed tool onto their workspace, linking it to other tools within the workflow process and setting the tool's object properties if any. To facilitate the integration of third party tools, the present invention includes publishing specifications that require categorization of the tool's type and function. For example, the tool category may include import, imaging, recognition, decision, data collection, user interface or export. In addition, the tool may disclose the exported functions. Such exported function may include, but are not limited to, creating new jobs, creating the tool itself, destroying the tool, determining if jobs are ready for processing, processing the work itself and defining tool parameters. The tool may also disclose the version and author.

An advantage of the invention is its ability to provide one integrated platform that captures and/or accepts the different formats of information (paper, email, xml, edi, sound, video, images, raw data, etc.), processes that information with user defined rules, and allows for this to be done via a user defined workflow that relates to the customer's business process.

As tools are modified and made available on the workspace, when a workflow is opened that utilizes such a modified tool, the system automatically detects that the older tool can now be replaced with a later version and asks the editor if it can be replaced. If the editor agrees to the change, the tool is upgraded and the previously provided parameters are moved to the corresponding parameters in the newer tool. If the editor declines the upgrade, there is no upgrade in this instance.

Another advantage of the invention is that is significantly lowers software development and training costs.

Still another advantage of the invention is that it provides opportunities for third-party vendors to quickly and easily add functionality and interoperability between their product(s) and the platform.

### BRIEF DESCRIPTION OF THE DRAWINGS

For a fuller understanding of the invention, reference should be made to the following detailed description, taken in connection with the accompanying drawings, in which:

FIG. 1 is a screen shot of three categories of reusable tools for processing documents according to an embodiment of the invention.

FIG. 2 is a diagrammatic view of a visual design element showing a form removal component processing a TIFF image input according to an embodiment of the invention.

FIG. 3 is a screen shot of a drag-and-drop interface wherein the properties of the reusable components dropped onto the desktop workspace are exposed to the end user according to an embodiment of the invention.

FIG. 4 is a screen shot of a graphic flowchart representation of a workflow that searches for a purchase order value in an imaged document processed by OCR according to an embodiment of the invention.

FIG. 5 is a screen shot of processing in real time of a workflow that searches for a purchase order value in an imaged document processed by OCR according to an embodiment of the invention.

FIG. 6 is a screen shot of the graphic flowchart representation illustrated in FIGS. 4-5 but also showing the available capture tools for adding and/or modifying the workflow.

FIG. 7 is a screen shot of a transactional view of the process for searching for a purchase order value in an imaged document processed by OCR according to an embodiment of the invention.

FIG. 8 is a diagrammatic view of three screen captures showing individual viewers of both image and text data, the data represented by graphical objects according to an embodiment of the invention.

FIG. 9 is a screen shot of a computer assignment property wherein an individual tool's processing may be outsourced to another computer in a machine list.

FIG. 10A is a diagrammatic view of a workflow editor computer receiving input and outsourcing various tasks to other computers on the same network.

FIG. 10B is a diagrammatic view of a plurality of computers configured with the workflow editor that query a central database to process workflow.

FIG. 11 is a screen shot of an embodiment of the invention showing an empty desktop workspace, a toolbox window, an empty properties window, and an empty output window.

FIG. 12 is a screen shot of an embodiment of the invention showing an Import TIFFs tool selected by the end user but not yet dropped onto the desktop workspace.

FIG. 13 is a screen shot of an embodiment of the invention showing the Import TIFFs tool dropped onto the desktop workspace, exposing the tool's available parameters.

FIG. 14 is a screen shot of an embodiment of the invention showing an Export tool dropped onto the desktop workspace and linked from the Import TIFFs tool.

FIG. 15 is a screen shot of an embodiment of the invention showing a dialog box setting a path for the Import TIFFs tool.

FIG. 16 is a screen shot of an embodiment of the invention showing a Classify Images tool dropped onto the desktop workspace and linked from the Export tool.

FIG. 17 is a screen shot of an embodiment of the invention showing an Image Classification File List dialog box.

FIG. 18 is a screen shot of an embodiment of the invention showing a Complex Goto tool dropped onto the desktop workspace and linked from the Classify Images tool.

FIG. 19 is a screen shot of an embodiment of the invention showing an Equation dialog box for the Complex Goto tool setting the document type to “Invoice.”

FIG. 20 is a screen shot of an embodiment of the invention showing an Equation dialog box for the Complex Goto tool setting the document type to “CreditApp.”

FIG. 21 is a screen shot of an embodiment of the invention showing an Equation dialog box for the Complex Goto tool setting the document type to “Note.”

FIG. 22 is a screen shot of an embodiment of the invention showing an Equation dialog box for the Complex Goto tool setting the document type to “Stub.”

FIG. 23 is a screen shot of an embodiment of the invention showing export tools dropped onto the desktop workspace for documents identified as either an invoice, credit application, mortgage note or payment stub. Unidentified images are sent to an export tool captioned as “unknown.”

FIG. 24 is a screen shot of an embodiment of the invention showing the property editor for the “unknown” image export tool.

FIG. 25 is a screen shot of an embodiment of the invention showing an End tool terminating the workflow process.

FIG. 26 is a screen shot of an embodiment of the invention showing a light-gray square indicia around the Import TIFFs tool indicating images are present in its directory path for processing.

FIG. 27 is a screen shot of an embodiment of the invention showing a black square indicia around the Import TIFFs tool indicating it has been selected by the user.

FIG. 28 is a screen shot of an embodiment of the invention showing a black square indicia around the Export tool indicating it has been selected by the user.

FIG. 29 is a screen shot of an embodiment of the invention showing a black square indicia around the Classify Images tool indicating it has been selected by the user.

FIG. 30 is a screen shot of an embodiment of the invention showing a black square indicia around the Unknown Export tool indicating it has been selected by the user.

FIG. 31 is a screen shot of an embodiment of the invention showing a black square indicia around the End tool indicating it has been selected by the user.

FIG. 32 is a screen shot of an embodiment of the invention showing a drop-down menu box having a plurality of selections.

FIG. 33 is a screen shot of an embodiment of the invention showing an integer value displayed by the End tool.

FIG. 34 is a screen shot of an embodiment of the invention showing a dialog box listing a plurality of import tools.

FIG. 35 is a screen shot of an embodiment of the invention showing a dialog box that displays details of the E-mail capture tool.

FIG. 36 is a screen shot of an embodiment of the invention showing a dialog box listing a plurality of recognition and decision tools.

FIG. 37 is a screen shot of an embodiment of the invention showing a dialog box that displays details of a A2iA Check Reader tool.

FIG. 38 is a screen shot of an embodiment of the invention showing a dialog box listing a plurality of data collection tools, user interface tools, export tools, miscellaneous tools and special tools.

FIG. 39 is a screen shot of an embodiment of the invention showing a View Image tool inserted after an Export unknown tool in the workflow.

FIG. 40 is a screen shot of a modal dialog box for viewing images classified as unknown by the Classify Images tool.

### DETAILED DESCRIPTION OF THE PREFERRED EMBODIMENT

An embodiment of the present invention includes seven components: (1) flowchart; (2) tool; (3) batch; (4) job; (5) job object; (6) engine; and (7) database. A flowchart is a definition of discrete processes linked together in a way that intelligently guides the document/data from its point of capture to its designated destination using logic controlled processes. A tool is an object designed to perform a specialized operation on a document/data. A tool's operation on a document/data may provide a decision point that determines that document/data's next workflow path. A batch is a collection of documents/data that move through the workflow as a group. A job is the object that represents a document/data within a batch. A job will have one or more job objects. A job object is a data representation of the document/data. One document/data can have many representations (e.g., image, text, XML, etc.) as it moves through the workflow. The workflow engine orchestrates a document/data's interaction between the flowchart and its various tools. The database maintains the current state of the Workflow Production Environment (WPE).

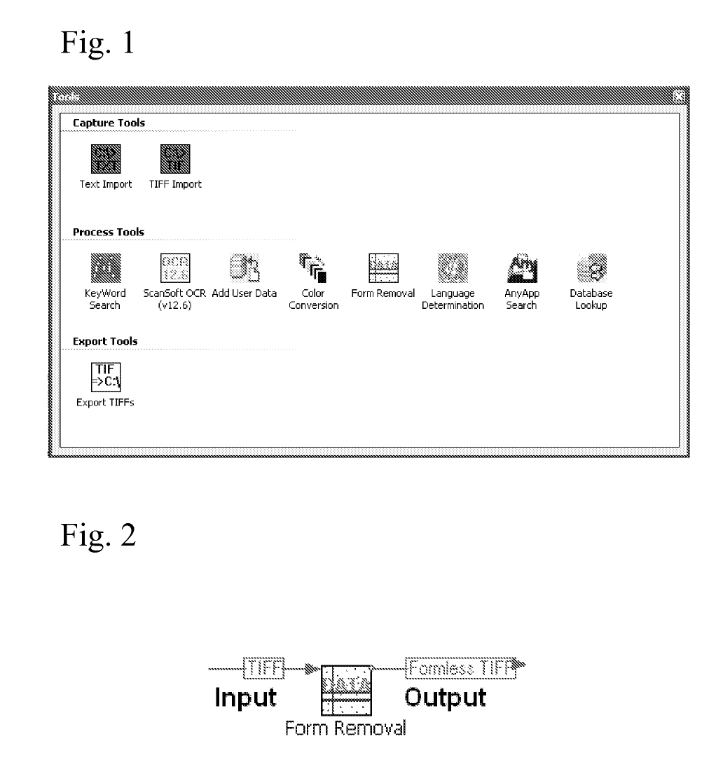

As shown in FIG. 1, there are several types of tools. A capture tool is responsible for bringing documents/data into the workflow. A process tool performs some type of operation on a document/data. This process may alter the document/data or generate new data into the system. This data may assist in a subsequent decision path that the associated document/data takes within the workflow. An export tool is responsible for moving a document and/or its associated data to its designated destination.

FIG. 2 illustrates connectors that link the tools within the workflow. A tool can have one or more inputs originating from other tools in the system. A tool can likewise have one or more outputs to subsequent tools in the system. The output connector path is based upon the processing logic of the associated tool.

The architecture of the workflow development platform (WPD) is object oriented, self encapsulated with no dependence on other tools. There are two models of engine interaction: (1) the engine waits for an active tool to complete its process; and (2) the engine gives work to a tool and continues processing. The tool notifies the engine when its process is complete. Plug-in support is provided via a published specification thereby allowing third-party customization of workflow via self-developed tools.

There are three types of tools provided with the core product (WPD) to allow an end-user to build business process (workflow) solutions: (1) capture; (2) processing; and (3) export. Capture tools include, but are not limited to: scanning, import, fax and email. Processing tools include, but are not limited to: image processing; full-text and/or keyword search on structured, unstructured and semi-structured documents; data transformations; business rules; scripting; language detection (French, German, Spanish, etc.); OCR/ICR/BCR/MICR/OMR (mark sense); classification; indexing; verification and quality assurance; email; and routing. Export tools include, but are not limited to: email; database; file system; and ECM, ERP, back-office.

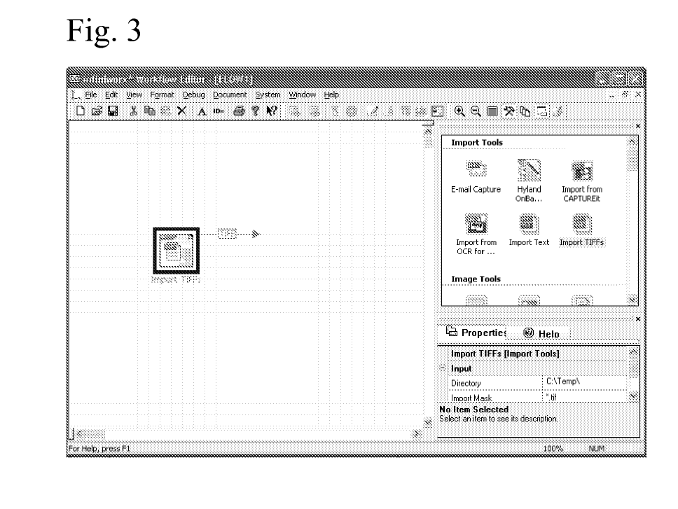

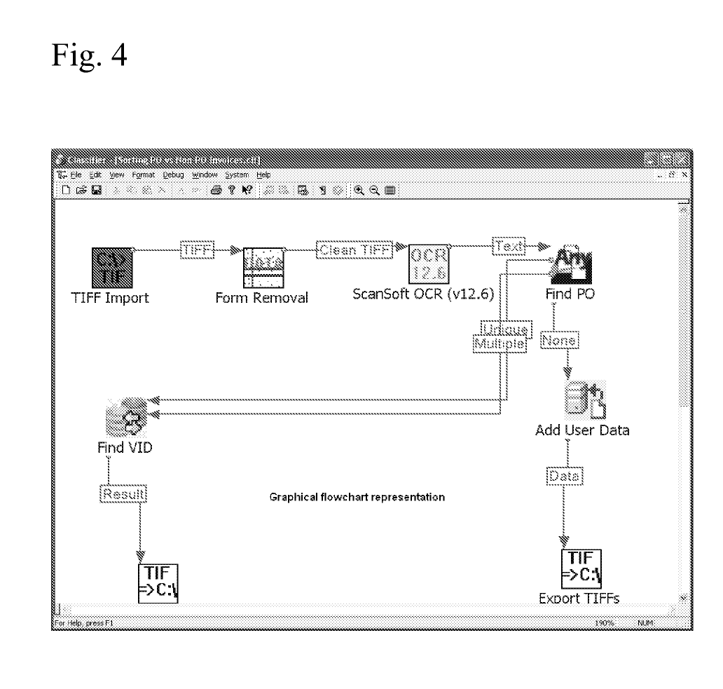

The user interface, as shown in FIG. 3 provides an integrated development environment (IDE) including a flowchart definition, drag and drop tools for the workspace and context sensitive parameters for each tool. FIG. 4 shows a graphical flow representation of a workflow beginning with a TIFF image import. The form indicia are removed and the TIFF is deskewed (horizontally and vertically aligned) and cleaned. The document is then processed by an OCR engine thereby producing text. An encapsulated logical process for finding a purchase order value is then executed in the process. If either unique or multiple purchase order values are obtained, they are queried against a database to possibly return a Vendor ID (VID) value. The returned VID value is then outputted as data with the associated TIFF document. Alternatively, if no purchase order value is found, user data is not added and then a separate TIFF document is generated.

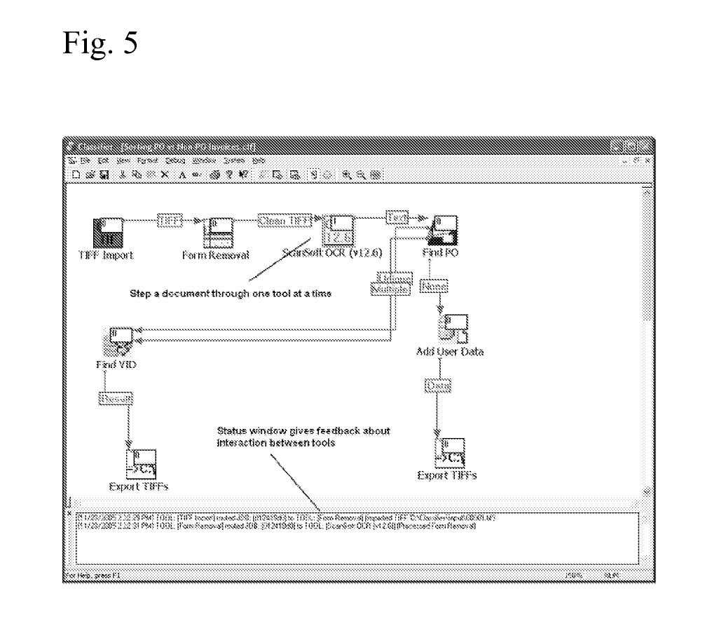

One novel feature of the present invention is the ability to visually test the document/data flow through WDP. As shown in FIG. 5, the process may be stepped through one tool at a time. A status window provides feedback about the interaction between tools. A batch of document/datas may be run through the entire workflow to visually evaluate the process.

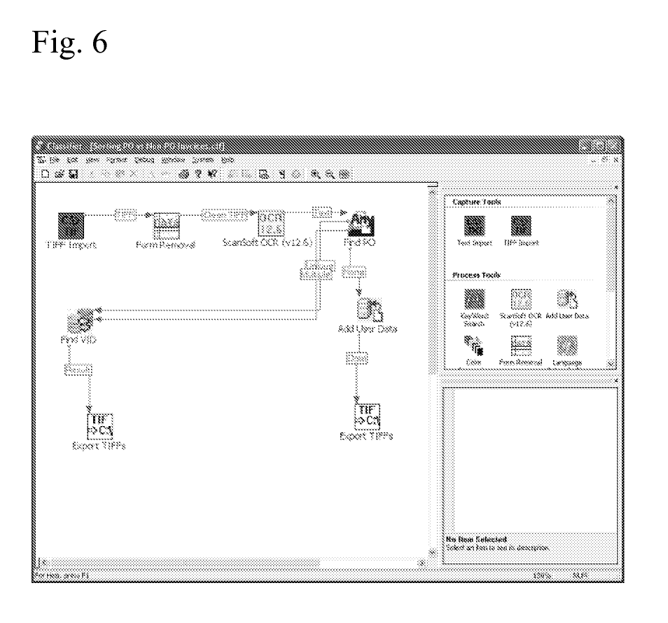

The flowchart definition view may be modified visually as well. FIG. 6 illustrates the same flowchart as shown in FIGS. 4-5. However, the interface in FIG. 6 provides a window of available tools for adding new encapsulated processes to the workflow.

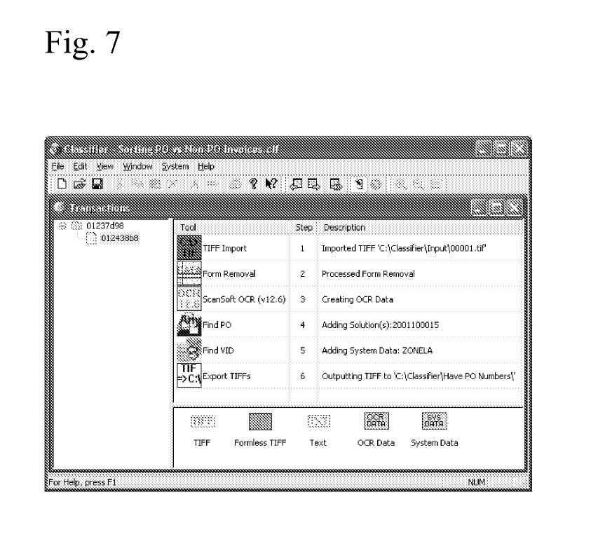

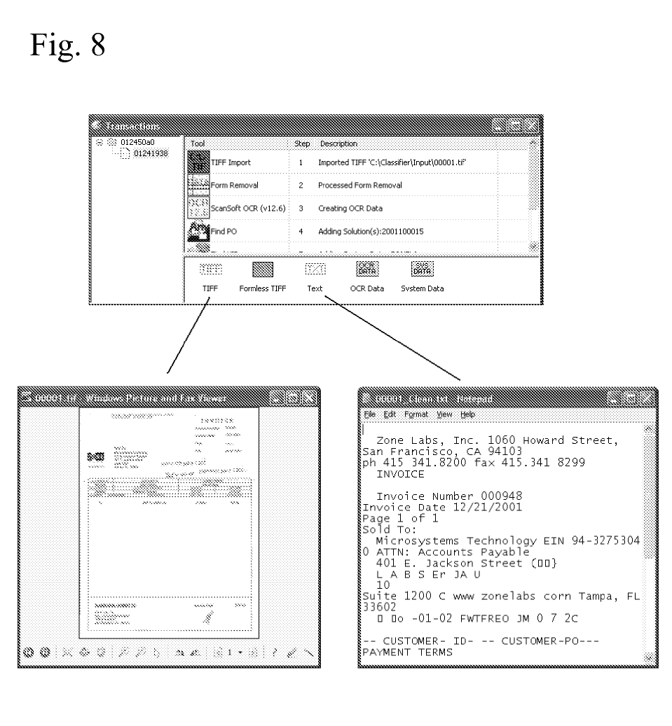

Yet another view of the workflow is provided in FIG. 7. A transaction view of an active document/data currently in WDP shows six steps including TIFF import, form removal, OCR processing, purchase order retrieval, database query, TIFF, and data export. In the window below the enumerated steps, the actual data is graphically represented as job object icons. Selecting these job object icons launch job object views as shown in FIG. 8. This permits the novice designer to have a complete, yet non-intimidating interface for creating sophisticated processes. This cannot be done with the same ease and efficiency under the current state of the art.

Once the process is visually designed and evaluated, it may be implemented in a workflow production environment (WPE) in unattended mode, unless a User Interface Tool is incorporated into the workflow. This typically invokes the engine only with no user interface. Multithreaded processes run as non-graphical services under the operating system without a local login executing the application. The WPE is database driven. The database maintains the state of all active document/datas within multiple workflow systems. This allows multiple production CPUs to run simultaneously.

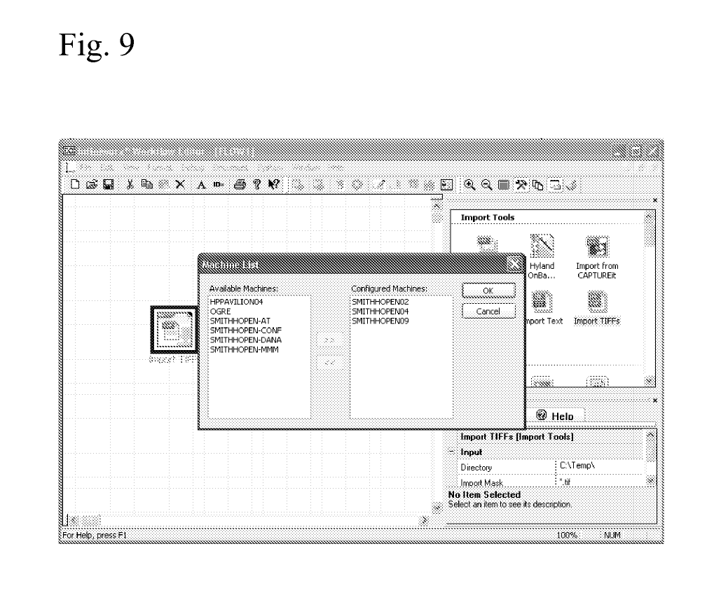

Turning now to FIG. 9, each individual tool's processing may be outsourced to another computer in a machine list. A machine list dialog box is provided showing available computers on a local area network in a first array and a second array of computers that are configured to run the individual tool's process. For example, some computers might have expensive OCR software resident on the operating system while other computers might only have the basic workflow application installed. If the tool requires OCR to work, then only those computers running the appropriate OCR software are available for outsourcing the tool's processing.

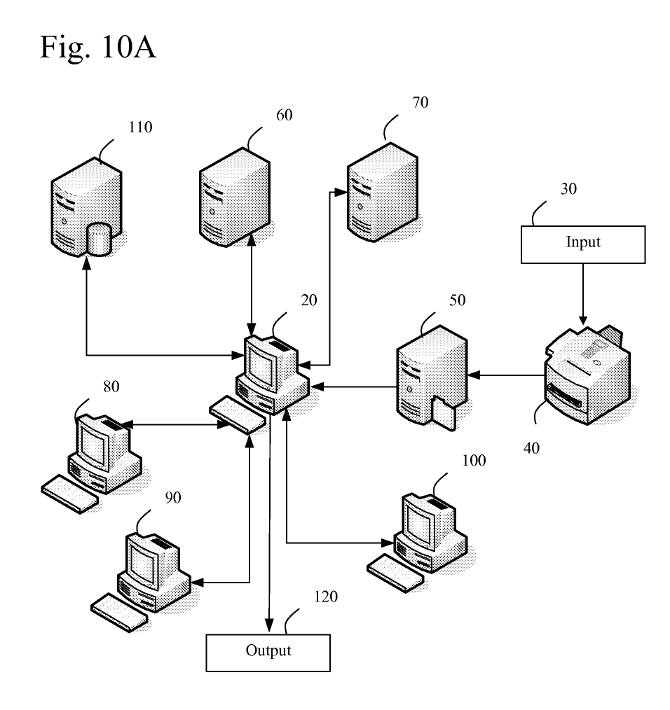

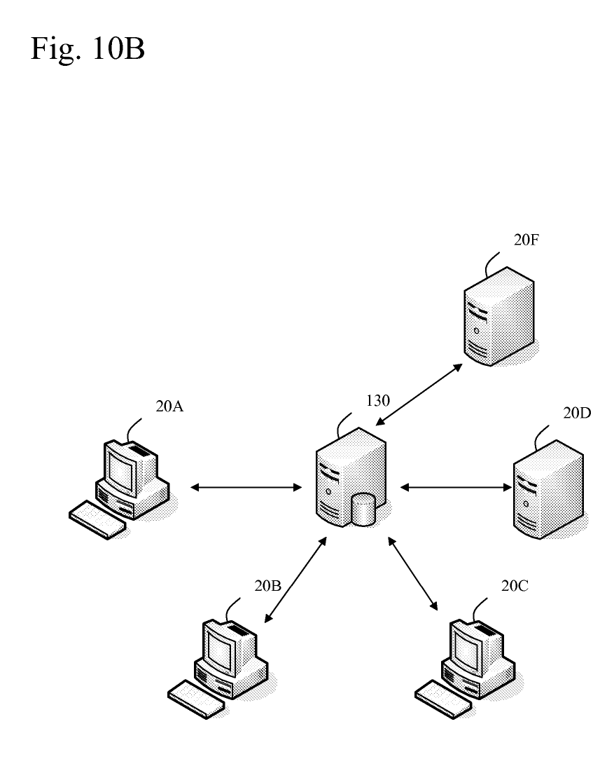

In FIG. 10A, workflow editor computer 20 authors a workflow to process inbound faxes 30. Fax server 40 receives analog fax input 30 and converts to a TIFF file saved on image server 50. Workflow editor computer 20 utilizes an Import TIFF tool, specifying a path to the directory on image server 50 where the inbound faxes 30 are stored as TIFFs. The workflow process requires each fax to be processed by OCR. However, prior to OCR processing each TIFF image must be cleaned by a Form Removal tool that removes lines, specks, miscellaneous noise, and also deskews the image. Workflow editor computer 20 outsources its Form Removal tool process to client computers 80, 90 and 100 when they are in an idle state and not used by an end user. By outsourcing to idle computers, workflow editor computer 20 distributes computing tasks to a plurality of preexisting, comparatively slower computers on the network. This allows a workflow processing entity to take advantage of preexisting infrastructure while providing substantial performance in the overall workflow process. OCR can be a computationally intensive task so workflow editor computer 20 outsources its OCR tool process to either first OCR server 60 or second OCR server 70, whichever is available to accept the task. First OCR server 60 and second OCR server 70 return alphanumeric text extracted from the OCR process to workflow editor computer 20. Finally, workflow editor computer 20 then queries database server 110 for a table lookup based on data extracted from the OCR process before exporting output 120.

FIG. 10B shows an alternative embodiment of the invention with respect to the previous figure. In FIG. 10B, workflow editor computers 20A-20F independently query common database 130. Common database 130 stores workflow configuration and state data. As workflow editor computers 20A-20F query common database 130 for work they are either given the next logical tool that they are authorized to process with exclusive access to all the jobs available for the tool or are given nothing to do because they do not qualify for any of the next available tools to be executed for the given workflow. Each workflow editor computer 20A-20F defaults to process any tool in a workflow. If only specific computers can be used for a specific tool (i.e., an OCR engine exists only on two of five computers) workflow editor 20 would configure those computers on each tool of the workflow for the configured computers that apply. As each workflow editor computer 20A-20F completes a job in the workflow, it updates common database 130 accordingly.

In an embodiment of the invention, workflow editor computers 20A-20F would automatically adjust thread priority according to the presence or absence of work to perform. For example, if no work was available to process on common database 130, then workflow editor 20 would drop its thread priority. Alternatively, if work was present, its thread priority would go up to complete pending work faster.

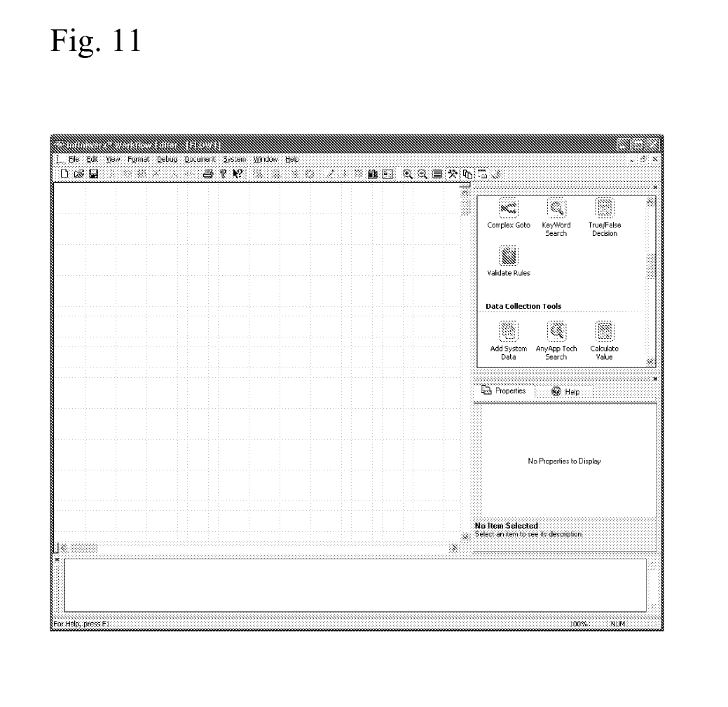

FIG. 11 shows an empty desktop workspace, a toolbox window and an empty properties window. Toolbox window and properties window are anchored to the right side of the form while the desktop workspace dimensions enlarge or reduce based on the overall dimensions of the application workflow itself. Thus, at higher screen resolutions, a maximized form window will display a larger desktop workspace than the same workspace at a lower resolution.

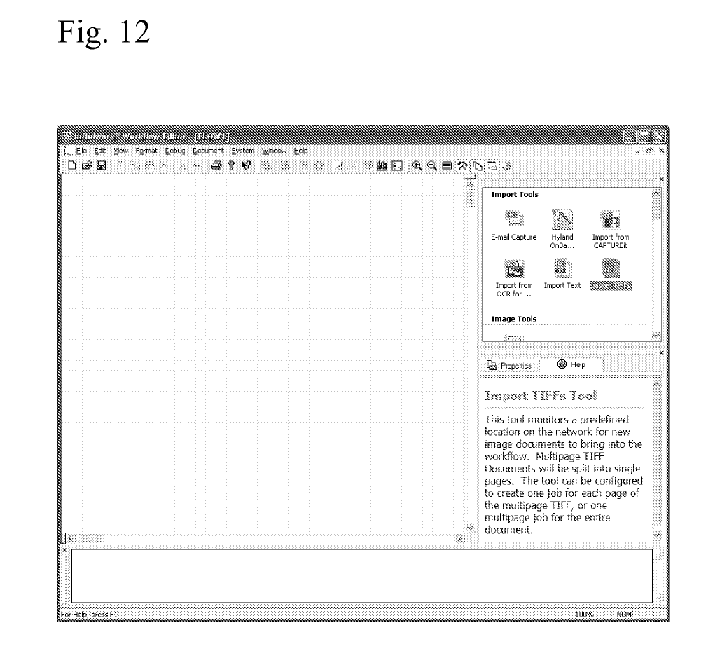

FIG. 12 is a screen shot showing an Import TIFFs tool selected by the end user but not yet dropped onto the desktop workspace. The selection of the Import TIFFs tool displays a string in a Help window that explains the use and function of the selected tool. Each tool is object oriented and a read-only property of each tool contains this help string value.

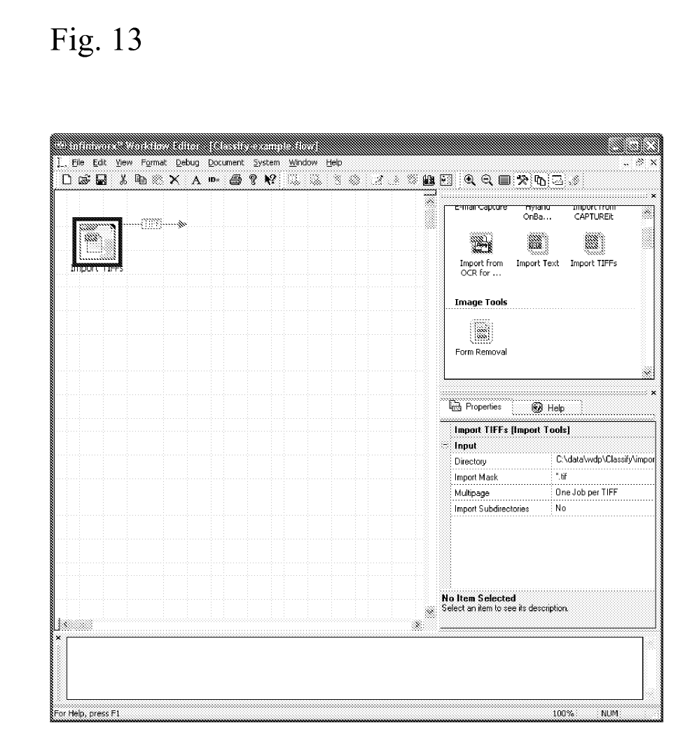

FIG. 13 shows the Import TIFFs tool dropped onto the desktop workspace. The tool automatically displays a graphical connector for visually linking itself to the next tool (not yet present). A default caption on the graphical connector also indicates the output from the tool will be a TIFF image. The Import TIFF tool is selected and thus automatically activates the tool's property editor. The Import TIFF tool has four properties that may be modified: (1) the directory path; (2) the import mask; (3) whether the image should be processed as a multipage TIFF; and (4) whether the tool should import TIFFs from subdirectories under the directory path.

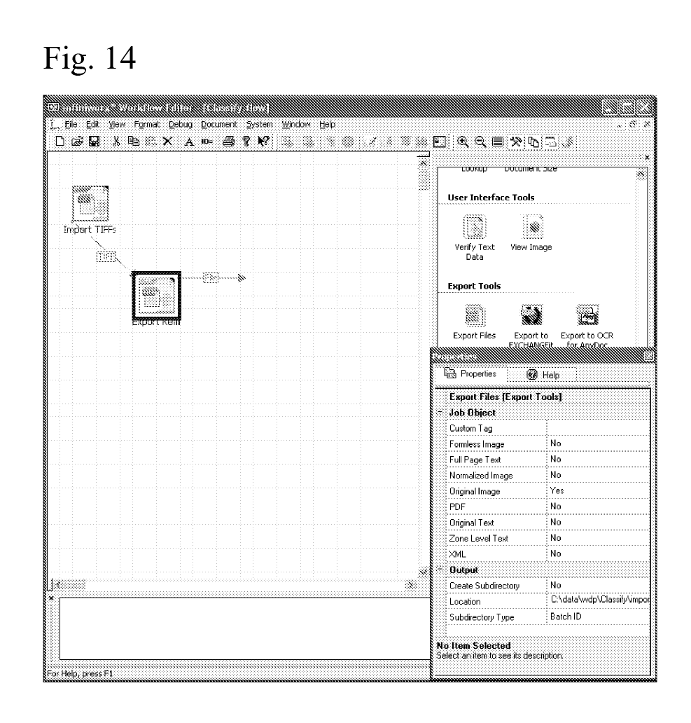

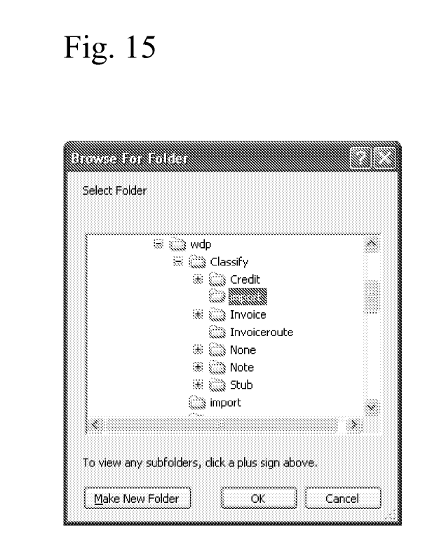

FIG. 14 shows an Export tool dropped onto the desktop workspace and linked from the Import TIFFs tool. The Export tool moves the TIFF from one location to another. Clicking on the location property of the Export tool produces the dialog box of FIG. 15 wherein the path for the Import TIFFs tool may be selected faster.

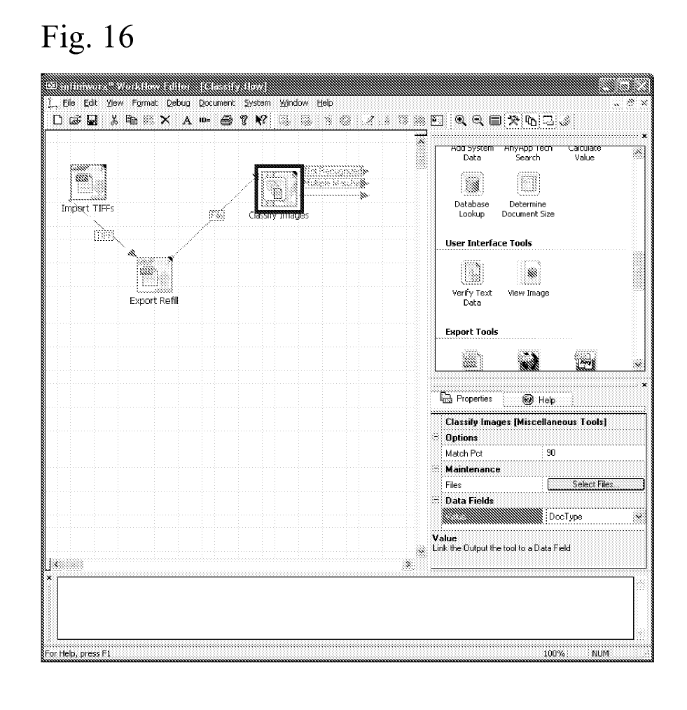

FIG. 16 is a screen shot showing a Classify Images tool dropped onto the desktop workspace and linked from the Export tool. The Classify Images tool performs image identification against a predefined set of forms. When the tool is dropped onto the desktop workspace, three graphical connectors are automatically displayed: (1) a connector for a recognized image; (2) a connector for an image resulting in multiple matches; and (3) connector for an image that is not recognized.

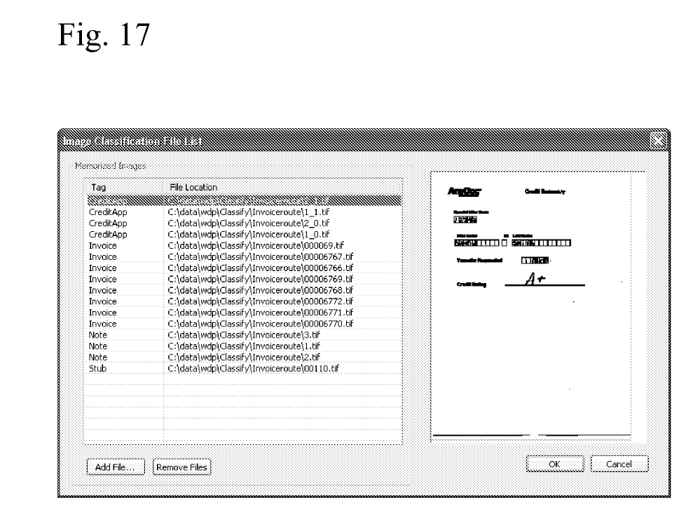

FIG. 17 is a screen shot showing an Image Classification File List dialog box. TIFF image paths and a tag are entered into the dialog box. The tags include CreditApp, Invoice, Note and Stub. The Classify Images tool analyzes the TIFF images against these memorized images for classification by the appropriate tag.

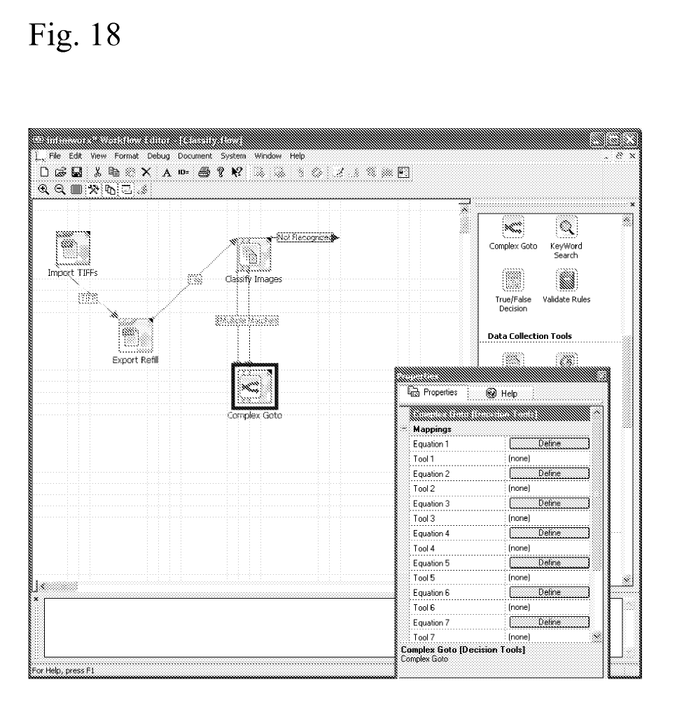

FIG. 18 is a screen shot showing a Complex Goto tool dropped onto the desktop workspace and linked from the Classify Images tool. The properties of the Complex Goto tool include a plurality of equations which may be defined.

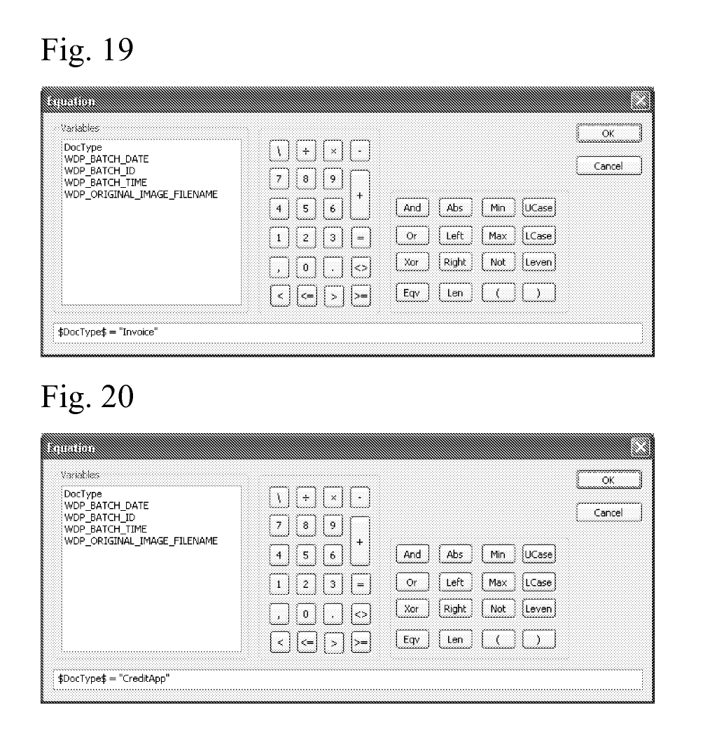

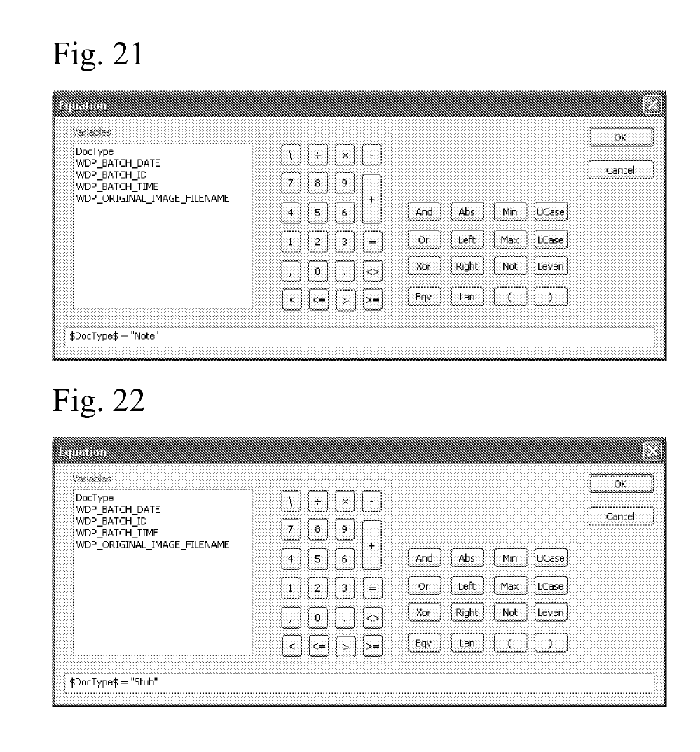

FIGS. 19-22 are screen shots showing Equation dialog boxes for the Complex Goto tool setting the document type to Invoice, CreditApp, Note and Stub respectively. Additional string and mathematical processing may be performed through the Equation dialog box without resorting to writing code.

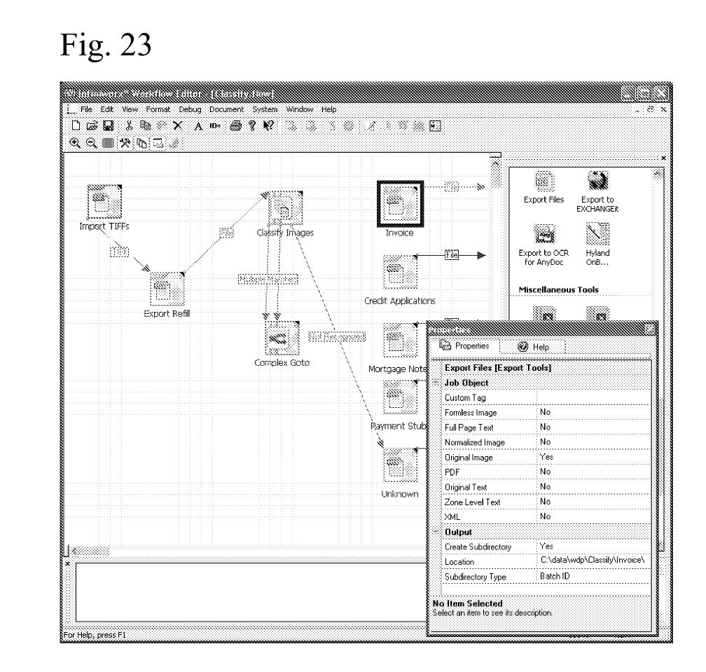

FIG. 23 is a screen shot showing export tools dropped onto the desktop workspace for documents identified as either an invoice, credit application, mortgage note or payment stub. Unidentified images are sent to an export tool captioned as “unknown.” Each export tool has its own distinct output location path whereby TIFFs classified as invoices are saved to one file directory, TIFFs classified as credit applications are saved to a second file directory, and so on. Files classified as either an invoice, credit application, mortgage note or payment stub residing in a homogenous file directory may be picked up by yet another workflow process to handle them according to their respective classifications and additional business processing requirements.

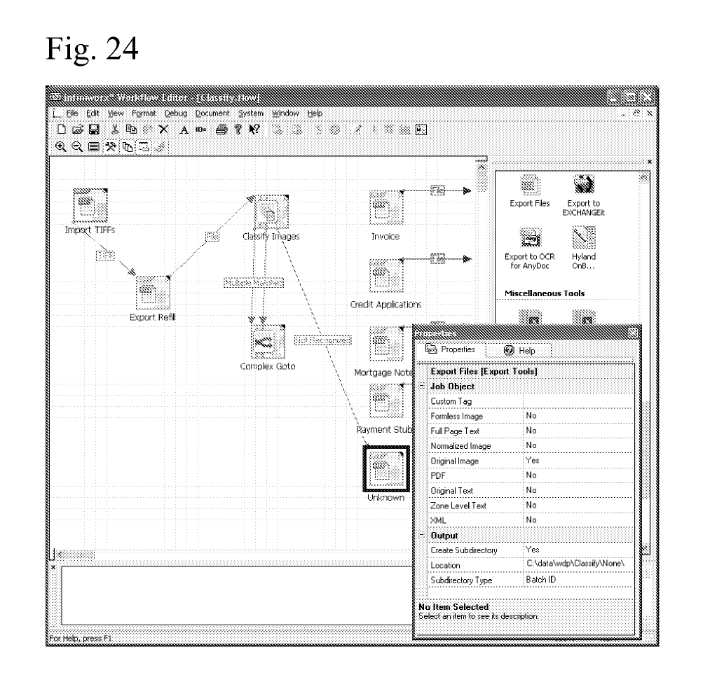

FIG. 24 shows the property editor for the “unknown” image export tool. These files are saved to yet another file directory path. Since these files were not classified as either an invoice, credit application, mortgage note or payment stub files classified as “unknown” may be considered exceptions and thus a notification to an end user may be generated to investigate or routed to another computer that also processes User Interface Tools, such as Verify Text Data, View Image, etc.

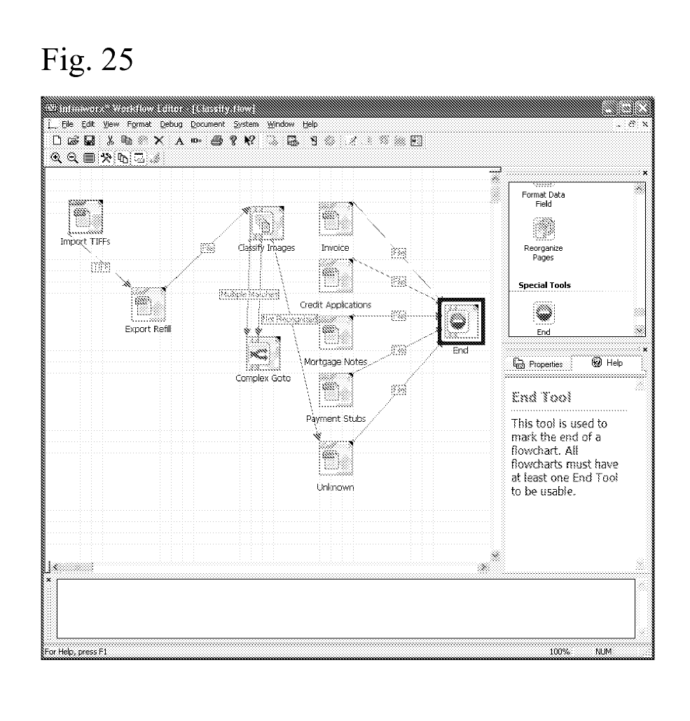

FIG. 25 is a screen shot of an End tool terminating the workflow process. All workflow flowcharts must have at least one End tool to be useable.

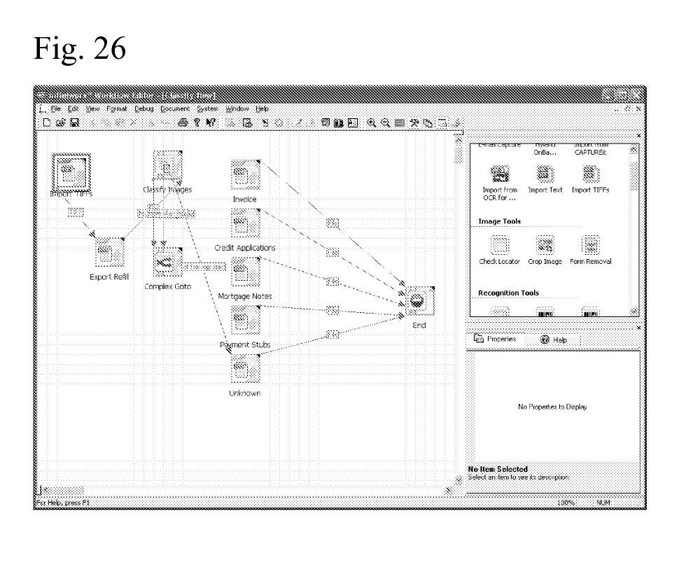

FIG. 26 is a screen shot showing a light-gray square indicia around the Import TIFFs tool indicating images are present in its directory path for processing. If no images exist in the directory path, then the light-gray square indicia (light green in the commercial embodiment of this invention) does not appear.

It should be noted that the present invention may simultaneously process multiple workflows on the same network environment.

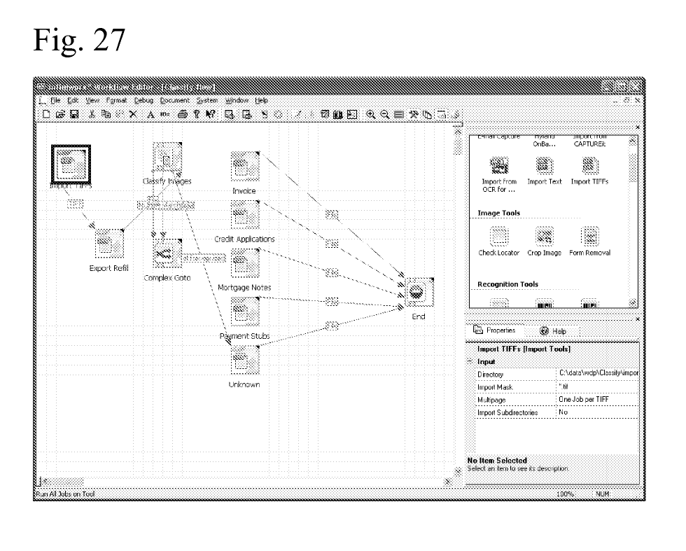

FIG. 27 is a screen shot of an embodiment of the invention showing a black (blue in the commercial embodiment) square indicia around the Import TIFFs tool indicating it has been selected by the user. The user selection also automatically displays the relevant properties for the tool in the property editor.

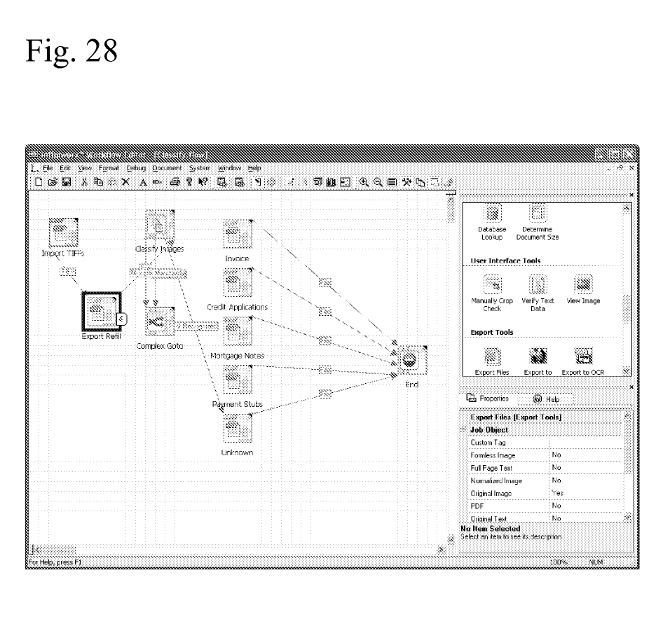

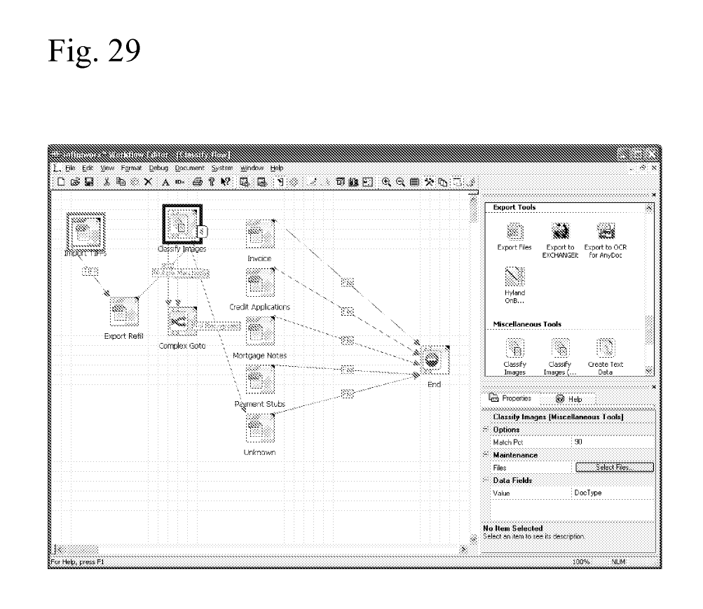

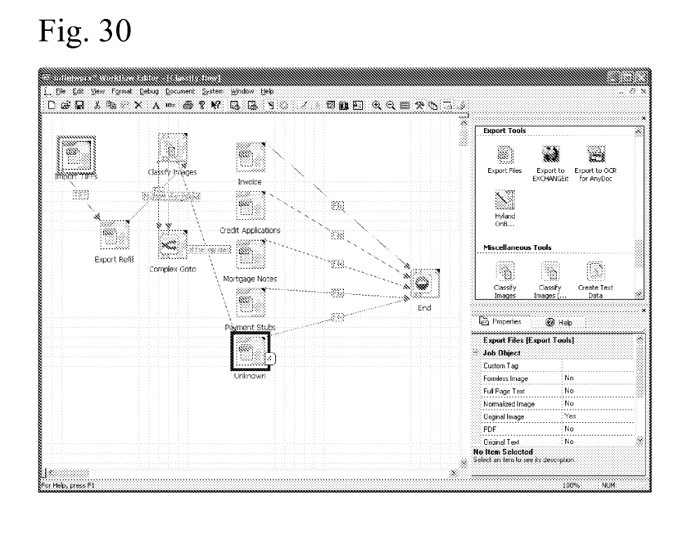

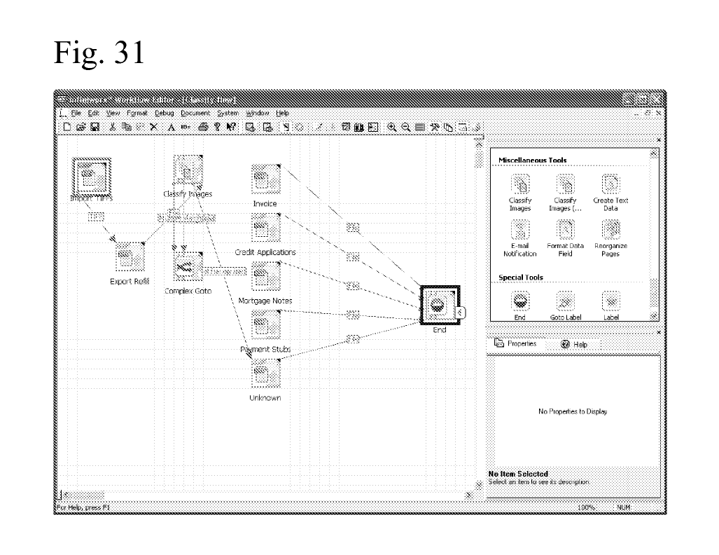

FIG. 28 is a screen shot showing a black square indicia around the Export tool indicating it has been selected by the user. FIG. 29 shows a black square indicia around the Classify Images tool indicating it has been selected by the user. FIG. 30 shows a black square indicia around the Unknown Export tool indicating it has been selected by the user. FIG. 31 is a screen shot showing a black square indicia around the End tool indicating it has been selected by the user.

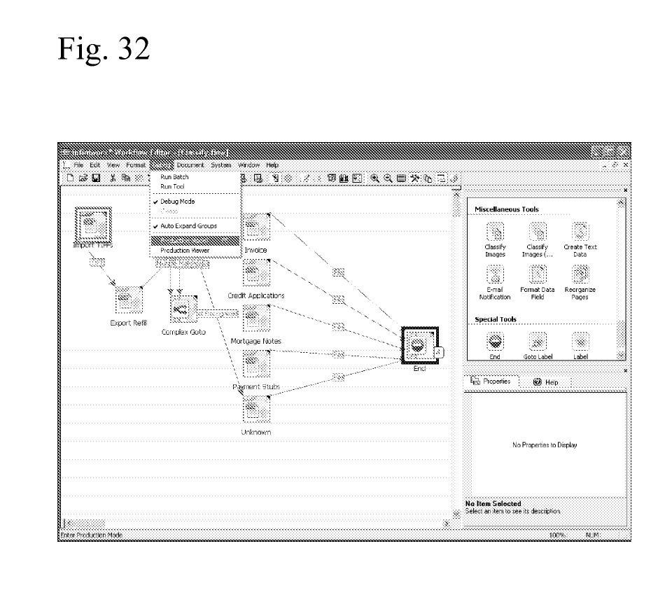

FIG. 32 is a screen shot showing a drop-down menu box with a plurality of selections. These selections include Run Batch which will process all the tools in sequence until the workflow process is completed. The Run Tool selection will step through each tool one at a time which is highly useful for debugging the workflow process. The debugging mode itself may be turned off or on. The desktop workspace is visible when in viewer mode selectable by the Production Viewer item. In production mode, the workflow editor GUI is hidden and the workflow process is run in an unattended fashion as a background application.

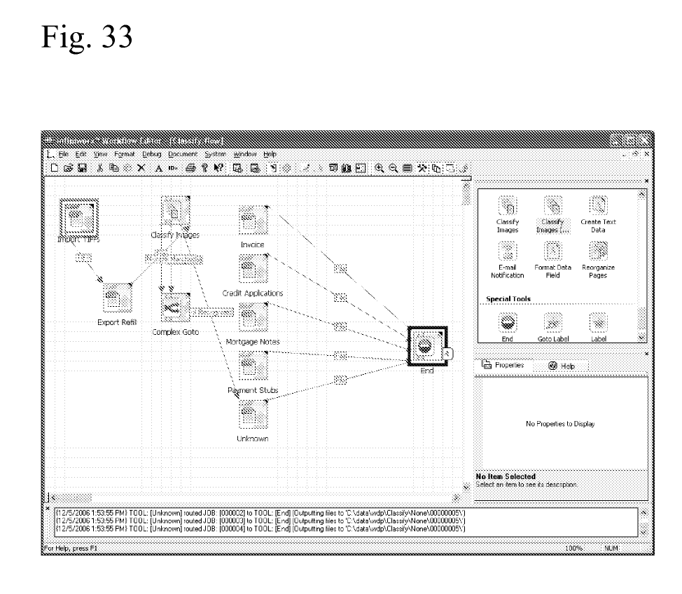

FIG. 33 is a screen shot showing an integer value displayed on the End tool. The integer value of 4 indicates that four (4) documents were processed by the End tool in the workflow.

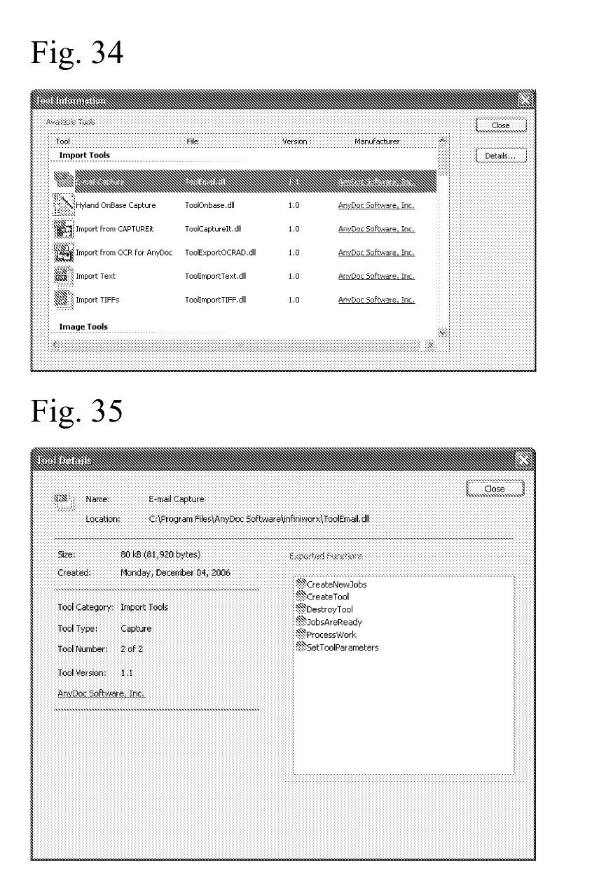

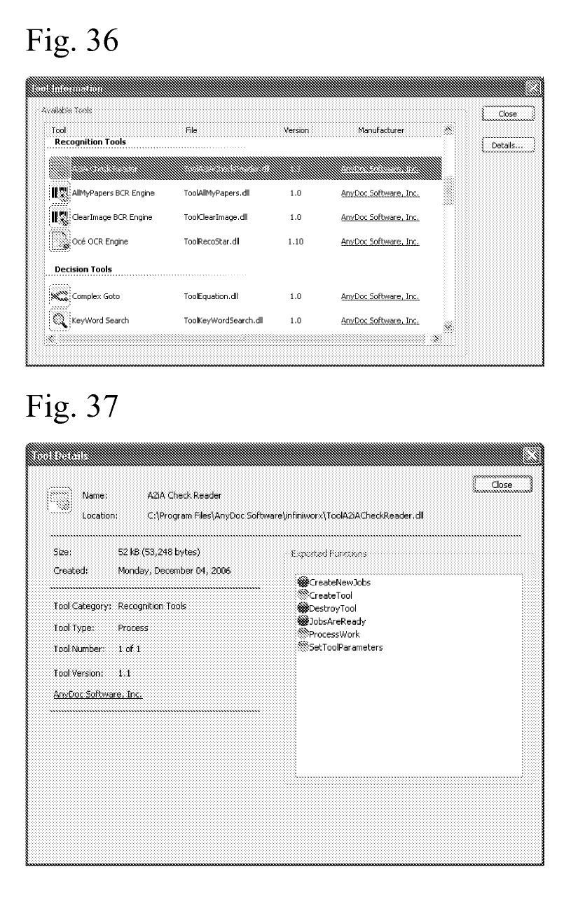

FIG. 34 shows a dialog box listing a plurality of import tools including E-mail Capture, Hyland OnBase Capture, Import from CAPTUREit, Import from OCR for AnyDoc, Import Text and Import TIFFs. FIG. 35 shows a dialog box showing details of the E-mail capture tool which include the tool name, its file path, size, create date, tool category, tool type, tool number, version, manufacturer or author with an embedded hyperlink to the author's website and an array of exported functions. FIG. 36 is a screen shot showing a dialog box listing a plurality of recognition and decision tools and FIG. 37 shows a dialog box showing details of a A2iA Check Reader tool.

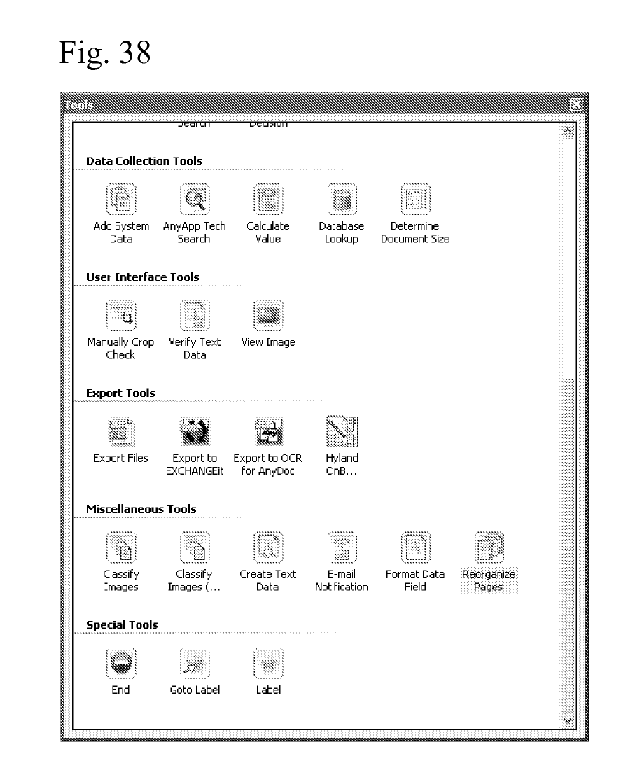

FIG. 38 is a screen shot of a dialog box listing a plurality of data collection tools, user interface tools, export tools, miscellaneous tools and special tools.

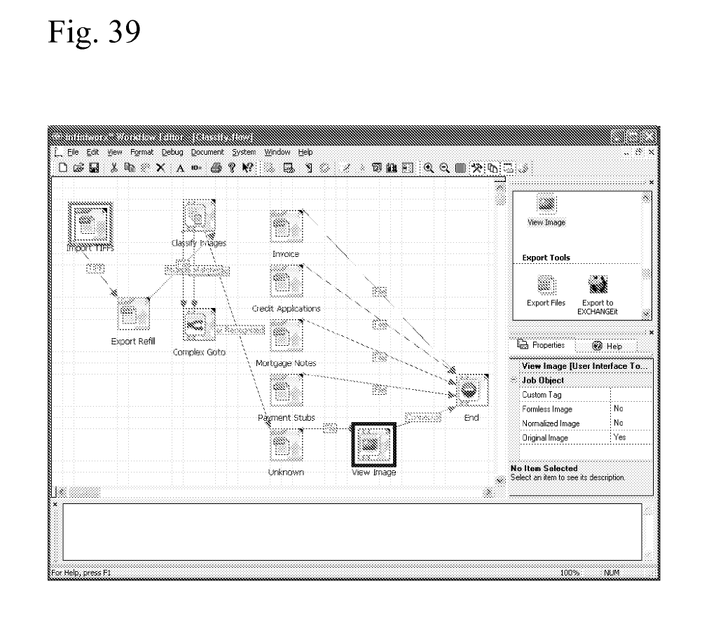

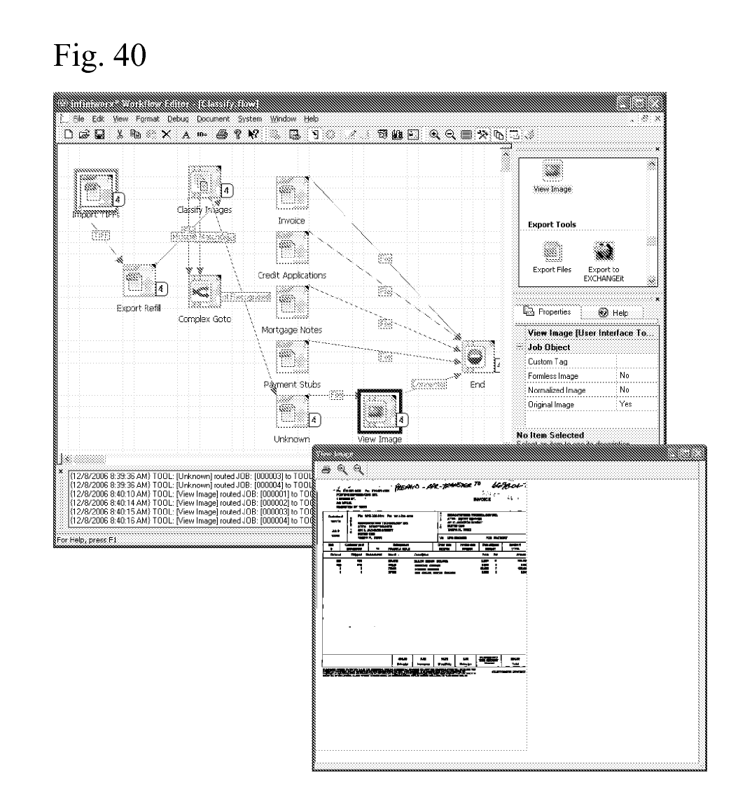

An objective of workflow processing as a whole is that it should be substantially unattended and automated. Human intervention should be limited to handling exceptions in the workflow process. For example, in FIG. 39, there is no need for human intervention if the Classify Images tool determines the imported TIFF is either an invoice, credit application, mortgage note or payment stub. However, if the Classify Images tool cannot identify the imported TIFF it is classified as “unknown.” This unknown image may require human interaction to determine what type of image it truly is, whether it should be reclassified, discarded, or the like. Turning to FIG. 40, when the workflow process arrives at the View Image tool, a modal dialog box appears displaying the unclassified unknown image to the end user. Alternatively, without the View Image tool in place, the unknown images are automatically exported to a separate directory without interrupting the workflow process wherein they may be viewed asynchronous to the workflow process. Thus, the workflow editor has a viewer mode for direct observational processing of the workflow with visual indicia responsive to the processing of each tool, an attended production mode wherein certain stages within the workflow (i.e., exceptions) suspend further processing of the workflow until an end user engages the editor, and an unattended production mode wherein the workflow processes without any end user intervention.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A graphical workflow editor comprising:
a desktop workspace;
a plurality of object-oriented tools selectively dragged and dropped onto the workspace, each tool performing at least one predefined role in a workflow process;
a property editor for modifying properties exposed by the tool dropped onto the workspace;
a graphical connector for visually linking one tool to another according to the tool's role in the workflow process;
a viewer mode for monitoring the workflow process whereby each tool provides visual indicia responsive to its activity state in the workflow process;
an attended production mode whereby activity of preselected tools suspend the workflow process until an end user engages the editor; and
an unattended production mode for unattended processing of the workflow process without end user engagement.

2. The editor of claim 1 further comprising a computer assignment property adapted to execute a tool's predefined role on one or more designated computers within a network.

3. The editor of claim 1 wherein third-party tools may be incorporated into the editor and interoperate within a workflow.

4. The editor of claim 1 wherein the viewer mode may incrementally step through the workflow process one tool at a time.

5. The editor of claim 4 wherein each tool displays an integer associated with the number of functions executed by the tool.

6. The editor of claim 1 wherein the graphical connector provides visual indicia responsive to the transition from one tool to another during the workflow process in the viewer mode.

7. A graphical workflow editor comprising:
a desktop workspace;
a plurality of object-oriented tools selectively dragged and dropped onto the workspace, each tool performing at least one predefined role in a workflow process;
a property editor for modifying properties exposed by the tool dropped onto the workspace;
a viewer mode for monitoring the workflow process whereby each tool provides visual indicia responsive to its activity state in the workflow process, the viewer mode incrementally executing the workflow process one tool at a time;
an attended production mode whereby activity of preselected tools suspend the workflow process until an end user engages the editor;
an unattended production mode for unattended processing of the workflow process without user engagement; and
a graphical connector for visually linking one tool to another according to the tool's role in the workflow process, the graphical connector providing visual indicia responsive to the transition from one tool to another during the workflow process in the viewer mode.

8. A graphical workflow editor comprising:
a desktop workspace;
a plurality of object-oriented tools selectively dragged and dropped onto the workspace, each tool performing at least one predefined role in a workflow process;
a property editor for modifying properties exposed by the tool dropped onto the workspace;
a computer assignment property adapted to designate another computer within a network to execute a tool's predefined role on one or more designated computers within a network;
a viewer mode for monitoring the workflow process whereby each tool provides visual indicia responsive to its activity state in the workflow process, the viewer mode incrementally executing the workflow process one tool at a time;
an attended production mode whereby activity of preselected tools suspend the workflow process until an end user engages the editor; and
an unattended production mode for unattended processing of the workflow process without user engagement.

9. A graphical workflow editor comprising:
a desktop workspace;
a plurality of object-oriented tools selectively dragged and dropped onto the workspace, each tool performing at least one predefined role in a workflow process;
a property editor for modifying properties exposed by the tool dropped onto the workspace;
a computer assignment property adapted to designate another computer within a network to execute a tool's predefined role on one or more designated computers within a network;
a viewer mode for monitoring the workflow process whereby each tool provides visual indicia responsive to its activity state in the workflow process, the viewer mode incrementally executing the workflow process one tool at a time;
an attended production mode whereby activity of preselected tools suspend the workflow process until an end user engages the editor;
an unattended production mode for unattended processing of the workflow process without user engagement; and
a graphical connector for visually linking one tool to another according to the tool's role in the workflow process, the graphical connector providing visual indicia responsive to the transition from one tool to another during the workflow process in the viewer mode.
